(19) United States
(12) Patent Application Publication
(10) Pub. No.: US 2005/0001473 A1
(43) Pub. Date: Jan. 6, 2005

(54) Method for actuating an external-force parking brake system

(76) Inventor: Heiner Messner, Kornwestheim (DE)

Correspondence Address: RONALD E. GREIGG;GREIGG & GREIGG P.L.L.C., Suite One, 1423 Powhatan Street, Alexandria, VA, 22314, US

(21) Appl. No.: 10/869,864

(22) Filed: Jun. 18, 2004

(30) Foreign Application Priority Data
Jun. 18, 2003 (DE) 1 03 27 567.3

(51) Int. Cl. B60T 17/16

(52) U.S. Cl. 303/89

(57) ABSTRACT

The invention relates to a method for actuating an external-force brake system of a hydraulic vehicle brake system. Upon actuation of the master cylinder, the invention proposes causing a wheel brake to communicate with a hydraulic reservoir by opening an associated outlet valve, and pumping the outflowing brake fluid with a hydraulic pump to a wheel brake that has a locking device. A switchover valve is closed in the process, and as a result the master cylinder is hydraulically disconnected from the vehicle brake system.

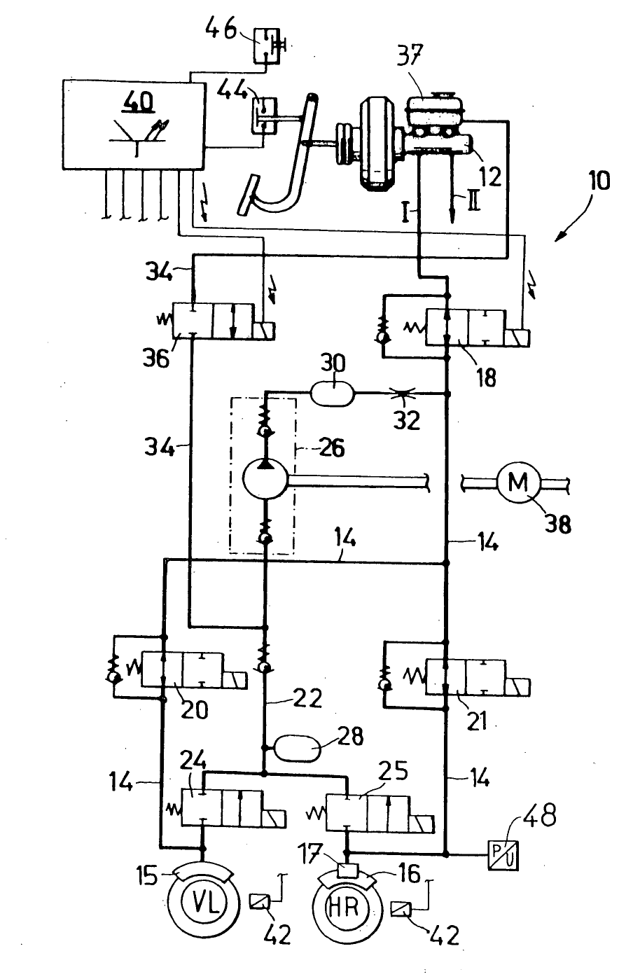

### BACKGROUND OF THE INVENTION

1. Field of the Invention

The invention relates to an improved method for actuating an external-force parking brake system in a hydraulic vehicle brake system.

2. Description of the Prior Art

It is standard now for passenger cars to be equipped with a hydraulic service brake system that is manually actuated by means of a pedal-actuated master cylinder. Typically, a negative-pressure brake booster is present, and electrohydraulic brake boosting with an electric-motor-driven hydraulic pump is also known. Often, the hydraulic service brake systems have an electric-motor-driven hydraulic pump, also called a return pump, for purposes of anti-lock braking, traction control, and/or electronic stability control (ABS, ATC, ESP), with which brake fluid can be pumped into or out of the wheel brakes in order to increase or decrease a wheel brake pressure in the wheel brakes. Below, for the sake of brevity, only anti-lock braking will be discussed. For that purpose, each wheel brake, or a group of wheel brakes, is preceded and followed by a brake pressure buildup and a brake pressure lowering valve, respectively. Such vehicle brake systems are known to one skilled in the art in various embodiments and will therefore not be described in further detail here.

Electrohydraulic service brake systems, that is, external-force service brake systems, are also known, in which a brake pressure is built up with an electric-motor-drivable hydraulic pump as the source of external energy. A brake pedal serves as the brake force set-point transducer, and a master cylinder is required only for auxiliary braking (emergency braking) if the external energy source fails. One such electrohydraulic vehicle brake system is disclosed in International Patent Disclosure WO 98/31576. The known vehicle brake system has an ABS device, which in principle is embodied identically to the ABS device described above in a muscle-power or auxiliary-force brake system, with the specification that the hydraulic pump forming the external energy source is also used for anti-lock purposes.

European Patent Disclosure EP 0 995 659 A1 discloses a vehicle brake system with a hydraulic service brake system and a likewise hydraulic external-force parking brake system (parking brake). For embodiment as a parking brake system, wheel brakes of the vehicle brake system have hydraulically actuatable, releasable locking devices, with which the wheel brakes can be mechanically locked in the actuated state. A brake force that has been built up is as a result maintained even if pressure fails. The locking can be activated hydraulically, electromechanically, or in some other way. For unlocking the locking device and releasing the parking brake system, it may be necessary to actuate the service brake system in order to release a mechanical tightening of the locking device and to make it possible to release the locking device, or to release it easily.

A wheel brake with a hydraulically switchable mechanical locking device is disclosed in German Patent Disclosure DE 195 02 927 A1. The method of the invention can also be used to release the parking brake system, and therefore actuating the parking brake system should also be understood in the sense of releasing the parking brake system.

### OBJECT AND SUMMARY OF THE INVENTION

For actuating the parking brake system with the service brake system actuated, the method of the invention having provides that brake fluid be allowed to overflow from at least one wheel brake cylinder into the hydraulic reservoir and be pumped from there by the hydraulic pump into a wheel brake that has a locking device. This has the advantage that by actuation of the service brake system, brake fluid under pressure is available for building up pressure for the external-force actuation of the parking brake system. Only if a volume and/or pressure of the brake fluid, flowing out of the wheel brake or wheel brakes into the hydraulic reservoir is inadequate for actuating the parking brake system must additional brake fluid be pumped with the hydraulic pump, for instance from a master cylinder or even better from a brake fluid supply tank, into the wheel brake that has the locking device. A pressure buildup for the external-force parking brake system is speeded up as a result, and the energy required for the pressure buildup is reduced.

### BRIEF DESCRIPTION OF THE DRAWING

The invention will be better understood and further objects and advantages thereof will become more apparent from the ensuing detailed description of a preferred embodiment taken in conjunction with the sole drawing FIGURE which shows a hydraulic circuit diagram of a vehicle brake system for performing the method of the invention.

### DESCRIPTION OF THE PREFERRED EMBODIMENTS

The drawing shows a hydraulic vehicle brake system 10 with a dual-circuit master cylinder 12, to which two brake circuits I, II independent of one another are connected; of them, only brake circuit I is shown in the drawing.

A branching master brake line 14 leads from the master cylinder 12 to two wheel brakes 15, 16, connected to this brake circuit I, and of these one wheel brake 16 has a locking device 17, with which the wheel brake 16 can be fixed, that is, mechanically locked, in the actuated position. Thus the vehicle brake system 10 has a hydraulically actuatable external-force parking brake system. The wheel brakes 15, 16 connected to one brake circuit I are assigned to one front wheel and one diagonally opposite rear wheel of a vehicle; the wheel brakes 15, 16 of the other brake circuit II are assigned to the other two vehicle wheels. The vehicle brake system shown and described accordingly has what is known as an X brake circuit distribution.

A switchover valve 18 that is open in its basic position is disposed in a common portion of the master brake line 14. Two inlet valves 20, 21 that are open in their basic position are also disposed in the branching parts of the master brake line 14 and are each upstream of one wheel brake 15, 16. From the wheel brakes 15, 16, a uniting return line 22, in which one outlet valve 24, 25 that is closed in its basic position is disposed for each of the two wheel brakes 15, 16, leads to the intake side of a hydraulic pump 26, which is also called a return pump. A hydraulic reservoir 28 is connected to the return line 22.

A pressure side of the hydraulic pump 26 is connected to the master brake line 14 via a damper chamber 30 and a throttle 32 between the switchover valve 18 and the inlet valves 20, 21.

Via an intake line 34, in which there is an intake valve 36 that is closed in its basic position, the intake side of the hydraulic pump 26 is connected to a brake fluid supply tank 37, which is seated on the master cylinder 12.

The hydraulic pumps 26 of the brake circuits I, II both shown and not shown can be driven by a common electric pump motor 38. All the valves listed up to now, namely the switchover valve 18, the inlet valves 20, 21, the outlet valves 24, 25, and the intake valves 36, are magnet valves, which for purposes of anti-lock and traction control are controllable with an electronic control unit 40, which also switches the pump motor 38 on and off. The electronic control unit 40 receives signals from wheel rotation sensors 42, which are evaluated in order to ascertain an inclination of a vehicle wheel to lock upon braking or to ascertain slip upon starting up. The control unit 40 also receives a signal from a brake pedal sensor (brake light switch) 44, with which an actuation of the master cylinder 12 can be ascertained.

With the vehicle brake system described, service braking is possible in a manner known per se. Anti-lock, traction control and/or electronic stability control (ABS, ATC, ESP) are also possible in a manner known per se. Below, for the sake of brevity, only the anti-lock mode will be discussed. To that end, wheel brake pressures in the wheel brakes 15, 16 are regulated (modulated) for individual wheels by means of the electronic control unit 40, by clocked control of the inlet valves 20, 21 and outlet valves 24, 25, in the course of which the hydraulic pump 26 is put into operation. The switchover valve 18 is closed for the anti-lock mode, and as a result the master cylinder 12 is disconnected hydraulically from the rest of the vehicle brake system 10. For a rapid pressure buildup in a traction control and/or electronic stability control event, the intake valve 36 is opened, so that the hydraulic pump 26 aspirates brake fluid directly from the brake fluid supply tank 37.

If a signal for actuating the parking brake system is issued by pressing a parking brake button 46, then the electronic control unit 40 checks, by means of the brake light switch 44, whether the master cylinder 12 and thus the service brake system is actuated. Regardless of this, the switchover valve 18 is closed, and in this way the master cylinder 12 is hydraulically disconnected from the rest of the vehicle brake system 10. If the master cylinder 12 was actuated before the switchover valve 18 was closed, then the outlet valve 24 of the wheel brake 15 that has no locking device is opened. As a result of the actuation of the master cylinder 12, the wheel brakes 15, 16 contain brake fluid that is under pressure. As a result of the opening of the outlet valve 24 of the wheel brake 15 that has no locking device, this wheel brake 15 is made to communicate with the hydraulic reservoir 28, and the brake fluid flows out of the wheel brake 15 into the hydraulic reservoir 28. The outlet valve 25 of the wheel brake 16 that has the locking device 17 preferably remains closed. The inlet valve 20 of the wheel brake 15 that has no locking device is closed, which can be done simultaneously with the opening of the outlet valve 24. The hydraulic pump 26 is driven by the electric motor 38 and pumps the brake fluid out of the hydraulic reservoir 28, through the open inlet valve 21 of the wheel brake 16 that has the locking device 17, into this wheel brake 16 until a predetermined wheel brake pressure, which is sufficient for the parking brake function, has built up in this wheel brake 16. The wheel brake pressure is measured with the pressure sensor 48 connected to the wheel brake 16. If the wheel brake pressure in the wheel brake 16 that has the locking device 17 does not reach the set-point value for the parking brake function, then the intake valve 36 is opened, and brake fluid is pumped by the hydraulic pump 26 out of the brake fluid supply tank 37 into the wheel brake 16 that has the locking device 17. If the set-point pressure has been reached, then the wheel brake 16 is fixed (locked) with the locking device 17, so that the built-up wheel brake force is maintained even if the wheel brake 16 is pressureless. The hydraulic pump 26 can be shut off and the magnet valves 18, 20, 21, 24, 25, 36 can be switched to be without current, so that they drop into their basic positions.

If the master cylinder 12 is not actuated, then the pressure buildup for actuating the parking brake system is effected by opening the intake valve 36 completely, using the hydraulic pump 26. The outlet valves 24, 25 remain closed; the inlet valve 20 of the wheel brake 15 that has no locking device is closed.

For unlocking the locking device 17 and releasing the wheel brake 16, it is possible by employing the method of the invention to effect a wheel brake pressure buildup in the wheel brake 16 that has the locking device 17, as long as the master cylinder 12 is actuated. As a result of the buildup of a wheel brake pressure, the locking device 17 is mechanically untensed and can as a result be easily released.

The foregoing relates to a preferred exemplary embodiment of the invention, it being understood that other variants and embodiments thereof are possible within the spirit and scope of the invention, the latter being defined by the appended claims.

1. A method for actuating an external-force parking brake system in a hydraulic vehicle brake system that has a hydraulic pump, in which the vehicle brake system has a service brake system with a hydraulic reservoir, which can be made to communicate with the wheel brake for lowering a wheel brake pressure in a wheel brake and for temporary storage of brake fluid from the wheel brake, the method comprising the steps of connecting the hydraulic reservoir (28) for communication with the wheel brake (15, 16) upon actuating of the service brake system, and then pumping brake fluid from the hydraulic reservoir (28) with the hydraulic pump (26) to a wheel brake (16) that has a locking device (18).

2. The method of claim 1, wherein only wheel brakes that do not have a locking device are connected to communicate with the hydraulic reservoir (28) for actuation of the parking brake system.

3. The method of claim 1, wherein the wheel brake (16) is again disconnected from the hydraulic reservoir (28) after an overflow of brake fluid from the wheel brake (15) communicating with the hydraulic reservoir (28).

4. The method of claim 1, wherein the parking brake system includes a manually actuatable master cylinder, and wherein the manually actuatable master cylinder (12) of the service brake system is disconnected hydraulically from the vehicle brake system for actuating the external force brake system.

5. The method of claim 1, further comprising pumping brake fluid by the hydraulic pump (26) from a brake fluid supply tank (37) to a wheel brake (16) that has a locking device (17).
